(19) United States
(12) Patent Application Publication
(10) Pub. No.: US 2008/0029229 A1
(43) Pub. Date: Feb. 7, 2008

(54) Profiled Bar with a Raising Mechanism for a Window or Door Covering

(76) Inventor: Grit Roetgering, Enter (NL)

Correspondence Address: JENSEN + PUNTIGAM, P.S., SUITE 1020, 2033 6TH AVE, SEATTLE, WA, 98121, US

(21) Appl. No.: 10/593,929

(22) PCT Filed: Mar. 17, 2005
(86) PCT No.: PCT/EP05/03753

§ 371 Date: May 25, 2007

(30) Foreign Application Priority Data
Mar. 22, 2004 (NL) 1025790
Jan. 18, 2005 (NL) 1028053

(51) Int. Cl. E06B 9/00; E06B 9/42

(52) U.S. Cl. 160/188

(57) ABSTRACT

A profiled bar for securement to the top of an opening, including a first internal longitudinal cavity to accommodate a raising mechanism for adjusting an attached covering for the opening, at least one opening into the cavity to accommodate at least one control cord which may be connected to the lower edge of the covering, and at least one second longitudinal cavity having a constricted opening along one edge of the bar of a size to accept one edge of the covering and which will prevent passage through the constriction.

The invention lies in the field of a variable covering for a window, a door or the like. Here can be envisaged a roller blind, a pleated blind, a sunblind consisting of slats, or the like which can be raised to leave clear the window or the door, or lowered to a desired position, in particular a lowest position in which the window or the door is completely screened by the covering.

Diverse raising mechanisms exist for coverings of the stated type. Some of these comprise a bar-like housing in which is accommodated a raising mechanism, for instance a roll-up mechanism. By means of control provisions, such as a control cord which co-acts with an control roller, or a manually rotatable shaft, it is possible for the covering to be raised or lowered.

The invention provides a profiled bar intended for fixing to the top side of a window, door or the like, which bar comprises:

an internal, preferably prismatic first cavity for accommodating a raising mechanism for raising cords for a variable covering for the window, the door or the like, such as a roller blind, a pleated blind or the like, which internal cavity is accessible from outside via continuous holes in the bar for passage of at least one control cord and at least two cords which are or can be connected for driving to the underside of the covering, for instance a substantially rigid beam connected to the lower edge of the covering;

at least one prismatic second cavity which extends in the longitudinal direction of the bar and which debouches via a constriction onto the outside of the bar, which second cavity serves to receive the upper edge of the covering, which is embodied such that it fits into this second cavity but is too wide to pass through the constriction;

two mutually coupled profiles which together bound the first cavity, in at least one of which profiles said holes are present.

A determined important embodiment has the feature that said two profiles consist of wood or a wood-like material. An attractive and aesthetic appearance in a determined style is thereby obtained.

A specific embodiment can have the special feature that the two profiles are prismatic. “Prismatic” is understood to mean a form in which the cross-section is the same at any position.

According to a determined aspect of the invention, the profiled bar has the special feature that both ends of the bar have openings which connect onto the first cavity and which are each closed by a plug.

With a view to an aesthetically attractive appearance, this embodiment preferably has the special feature that the plugs consist of the same material as the two profiles.

In the case where the end surfaces of the bar are not visible, for instance because on both sides they fit tightly, or more or less tightly, inside a window frame, the arranging of plugs is not essential, other than to prevent the entry of dirt and dust.

In a specific embodiment the profiled bar according to the invention has the special feature that the bar has continuous holes through which fastening screws can be placed to fasten the bar to the top part of a window, door or the like. A bar can hereby be fixed in very simple manner to an existing building construction.

The bar according to the invention preferably has the special feature that the two profiles are mirror-symmetrical.

This latter embodiment can even have the special feature that the two profiles are identical. Such an embodiment is very simple from a production engineering viewpoint. It is only necessary to manufacture one type of profile which is sawn into pairs of profiles of equal length, which profiles can be mutually connected for manufacture of the profiled bar according to the invention.

The latter variants are preferably embodied such that the two profiles are mutually coupled in the plane of symmetry extending through the prismatic second cavities.

In order to prevent excessive wear of the cords, use can be made of an embodiment in which the edges of the holes are rounded.

According to yet another aspect of the invention, the profiled bar has the special feature that the profiles are connected non-releasably to each other, for instance by glueing.

In a particular embodiment the profiled bar according to the invention has the feature that the raising mechanism comprises: a drive roller onto which the control cord engages for rotating driving thereof; and a number of wind-up rollers for the raising cords which are connected to this drive roller, for instance are arranged on the same shaft therewith.

In yet another embodiment the profiled bar according to the invention has the feature that the raising mechanism comprises:

guide means for the raising cords which are also the control cords;

wherein each of the cords is connected with a fixed end to the bar, extends downward and is trained through 180° round the upward windable or at least partially lower zone of the covering, extends upward again, enters the first cavity via a raising cord hole, extends therein in substantially horizontal direction, leaves the cavity once again via a control cord hole and extends downward therefrom in vertical direction.

In a specific, aesthetically attractive embodiment, the profiled bar according to the invention has the special feature that the two profiles consist of a transparent material, for instance a plastic such as acryl, polycarbonate or plexiglass. The use of a transparent material makes it possible to view the internal structure of the bar with the raising mechanism from outside. This is deemed an attractive exterior aspect.

In yet another embodiment, the profiled bar according to the invention has the special feature that the two profiles consist of a metal, for instance aluminium. Metal, in particular aluminium, has the advantage that it allows of easy processing on its exterior such that the appearance looks exceptionally smooth, graphic and more or less technical. This aspect is also considered aesthetically attractive by many. A metal such as aluminium can further be finished in diverse colours by means of anodization. In the case of both aluminium and for instance stainless steel, the outer surface can be burnished to a high-polish finish, brushed or given a matt finish, optionally in combination with said anodization. Use can also be made of a coating in the form of an epoxy material or a lacquer. The external recognizability of the material is lost here, although use can still be made of the technical qualities thereof, for instance strength, price/quality ratio, straightforward manufacture.

In yet another embodiment, the bar according to the invention has the special feature that the two profiles consist of an opaque plastic, for instance PVC, PP or PE. In this embodiment use can be made for manufacture of the two profiles of for instance an injection-moulding technique, whereby the profiles can be manufactured relatively inexpensively.

It is possible to see as a drawback of the injection-moulding technique that it is not always easy to manufacture profiles of differing lengths without complicated, costly and time-consuming change-overs of the injection-moulding device being necessary for this purpose.

With a view to the foregoing, the bar can have the special feature in a specific embodiment that the two profiles are each manufactured by extrusion. An extrudate can have a relatively great length and be brought to the desired length before being processed to a profile. Diverse plastics, optionally with fibre reinforcement, are suitable for extrusion. Specific types of aluminium are also suitable for an extrusion process.

The bar according to the invention can in principle be fixed in any desired manner to a building structure. Use can for instance be made of a number of screws, for instance of the self-tapping type. Preferably however, the bar according to the invention has the special feature that at least one of the two profiles is provided with a mounting profile, via which the relevant part can be fixed to the building structure. Such a mounting profile can very suitably be manufactured from aluminium. Aluminium is a material allowing relatively easy processing, is cheap and has an excellent ratio of the price and technical performance thereof.

A preferred embodiment has the special feature that the mounting profile takes a prismatic form.

According to yet another aspect of the invention, the bar has the special feature that the mounting profile is manufactured by extrusion.

It is noted that the extrusion profile can also be manufactured from a suitable plastic or can also form an integral part of the relevant part of the profiled bar. Usually however, the material chosen for the two profiles of the bar will differ from that of the mounting profile, in which case the bar and the mounting profile must be coupled to each other in a separate operation.

The invention will now be elucidated with reference to the annexed drawings of a number of random exemplary embodiments, to which the invention is not limited. In the drawings:

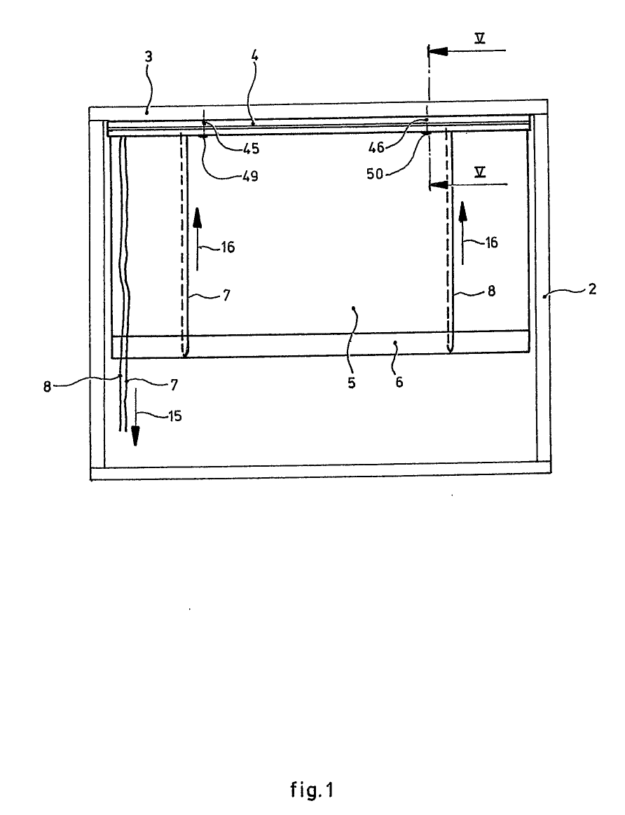

FIG. 1 shows a vertical view of a window with a window covering supported by a profiled bar according to the invention;

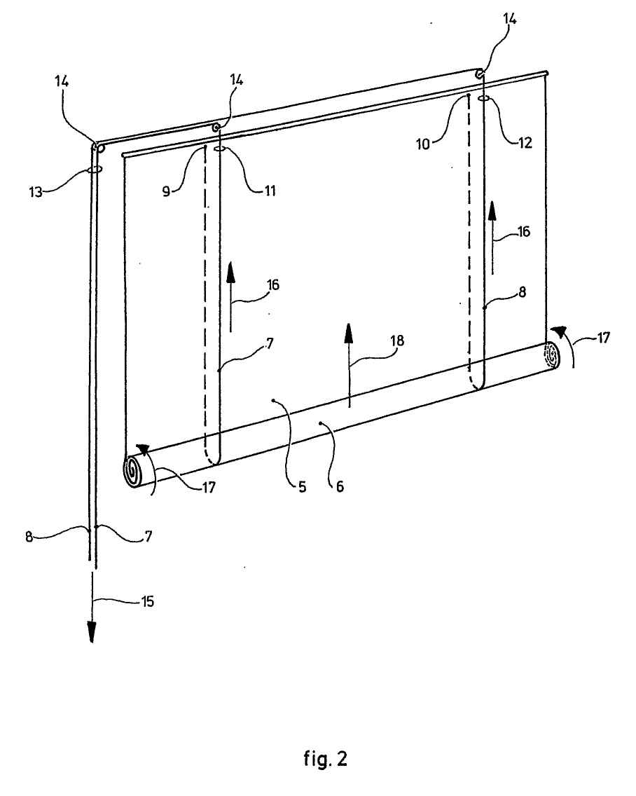

FIG. 2 shows a highly schematic perspective view of the raising mechanism as applied in the embodiment of FIG. 1;

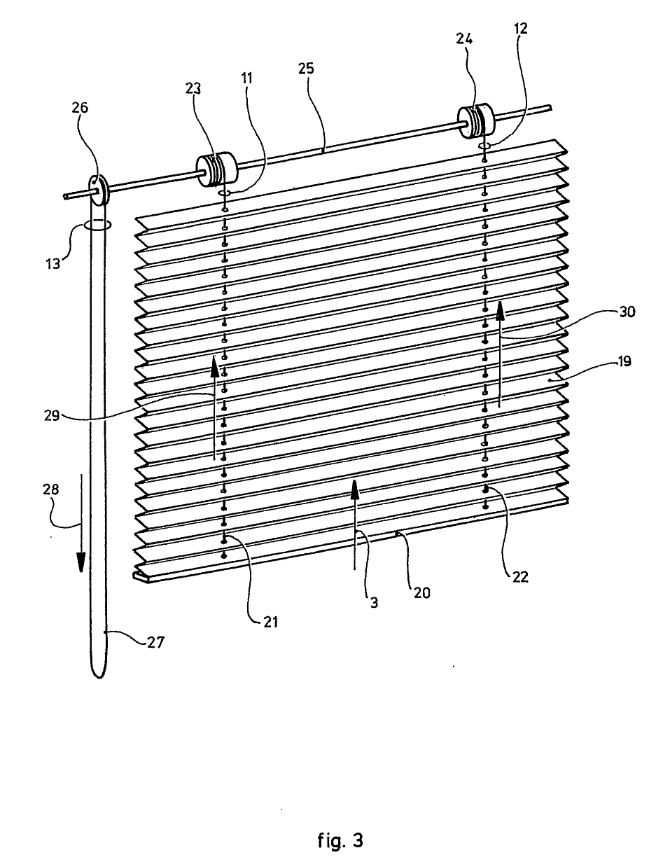

FIG. 3 shows a view corresponding with FIG. 2 of an alternative raising mechanism;

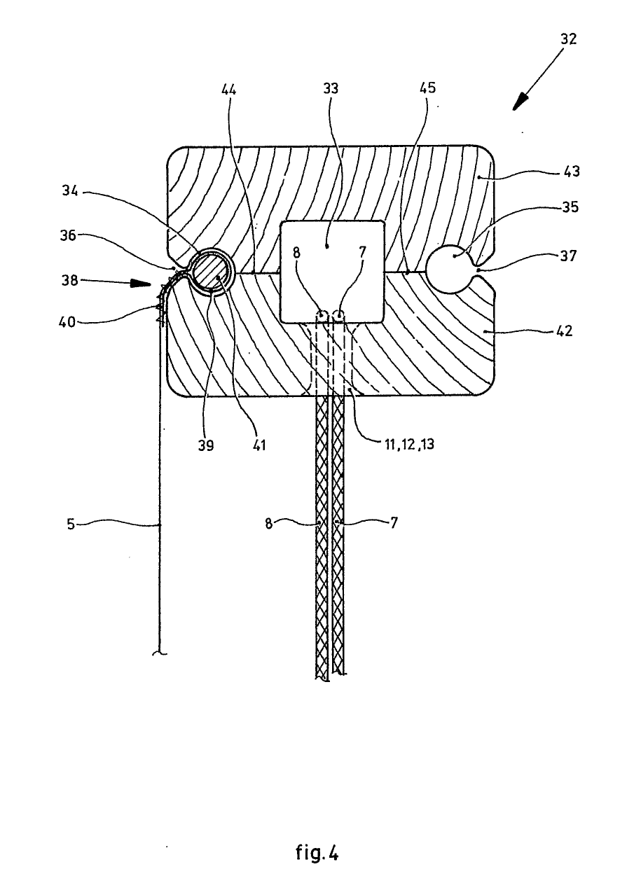

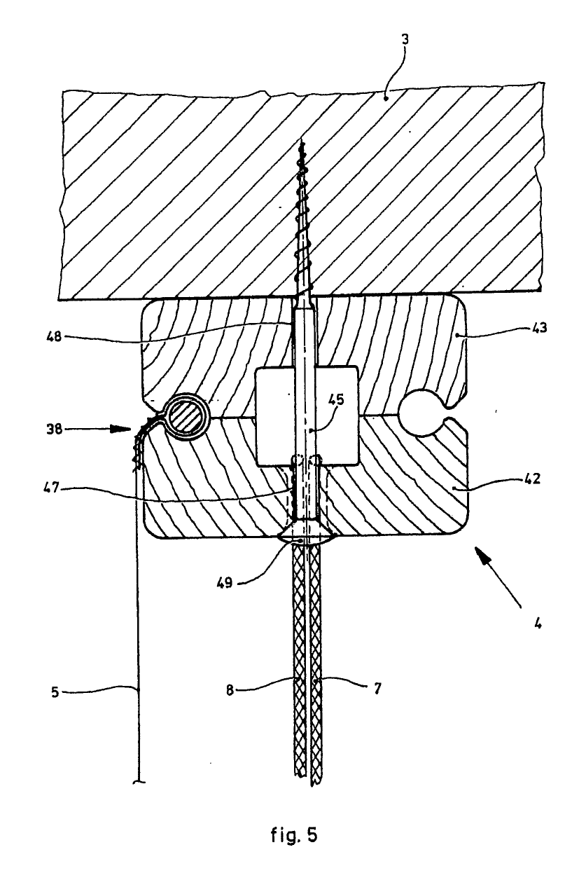

FIG. 4 shows an end view of a profiled bar according to the invention, wherein the plug on the end surface is omitted;

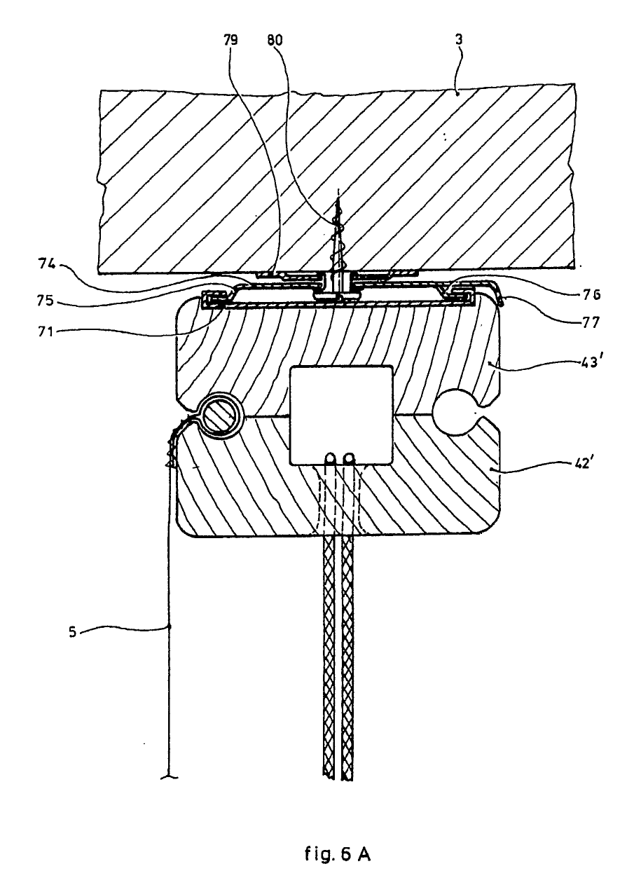

FIG. 5 shows a cross-section V-V from FIG. 1 of a profiled bar according to the invention fixed to the building construction;

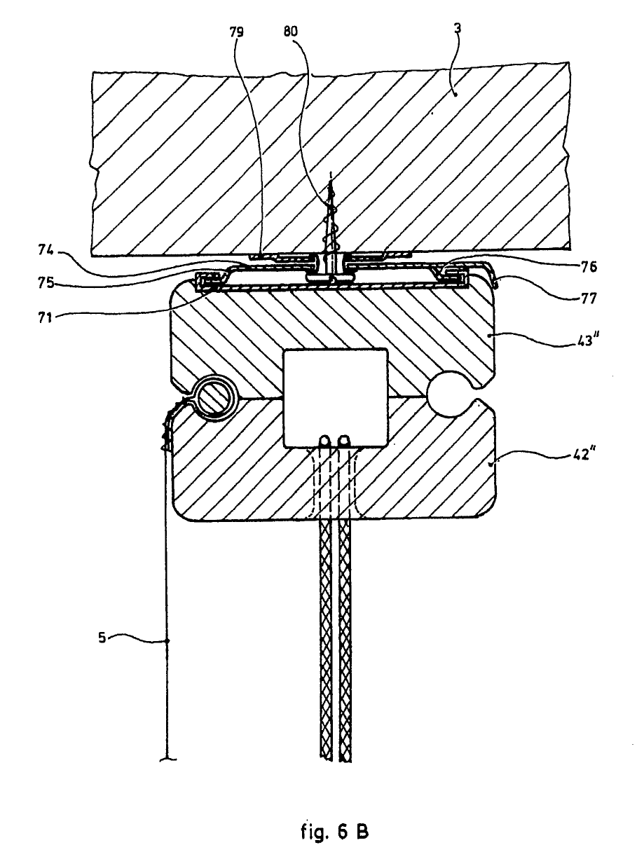

FIG. 6A shows a cross-section corresponding with FIG. 5 through a variant, wherein the bar is fixed to a building construction via a mounting profile;

FIG. 6B shows a view corresponding with FIG. 6A of an embodiment in which the two profiles of the bar consist not of wood, but of another material, such as an optionally transparent plastic or metal such as aluminium;

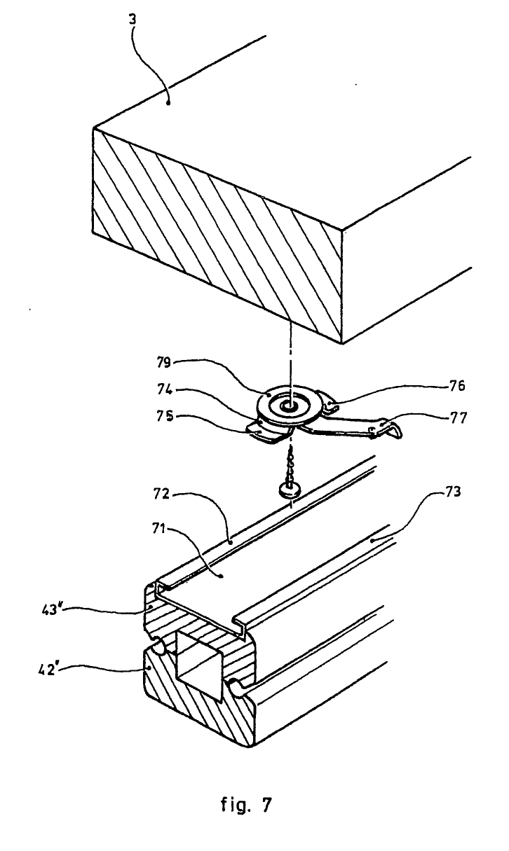

FIG. 7 is a partly perspective exploded view of the variant of FIG. 6b in the situation where the bar provided with a mounting profile has yet to be coupled to the building construction; and

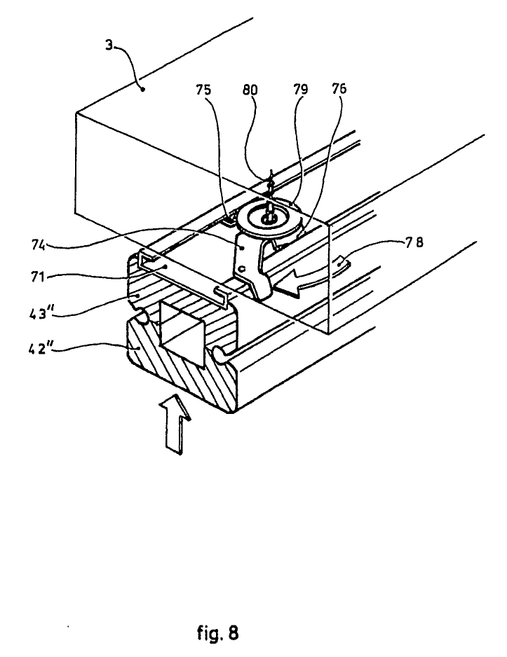

FIG. 8 is a perspective view, drawn partly transparently, of the position in which, after the situation shown in FIG. 7, the releasably mounted state is realized.

FIG. 1 shows a window 1 with a frame 2, to the upper beam 3 of which is fixed a profiled bar 4 according to the invention. Attached fixedly to bar 4 is a roller blind 5 which can serve as curtain or as sunblind. Roller blind 5 consists in this embodiment of a fabric and, in the situation shown in FIGS. 1 and 2, is partially rolled up at the bottom on a roller 6. The roller blind can also consist of wooden slats mutually connected by cord.

Roller 6 is held fast at the desired position by two cords 7, 8.

As shown particularly in FIG. 2, use is made of two raising cords 7 and 8 respectively which are fastened to bar 4 on the rear side at points 9, 10 respectively (in FIG. 2 the bar is not shown), extend downward from these points 9, 10, are trained 180° around the roller 6, extend upward from this position, then extend through schematically designated holes 11, 12 in the bar, extend in horizontal direction from this position and extend downward via a control cord hole 13. It is noted that a number of deflecting elements are drawn only for the sake of clarity in the drawing. These deflecting elements are all designated with 14. These elements are however not present. Guides 14 are only drawn for easy reference in FIG. 2. The rounding of the holes to be described hereinbelow serve to bend the cords 7, 8 over 90°. When a downward directed force is exerted on the free ends of cords 7, 8 as according to arrow 15, an upward directed force is exerted on the cords in the region of roller blind 5. This is indicated with 16. Roller 6 is hereby rolled up as according to arrows 17 and roller 6 is moved as according to an arrow 18, whereby roller blind 5 is raised. The free ends of cords 8, 9 can be secured in any desired position by means of a clamp connection or the like.

FIG. 3 shows an alternative raising system wherein a window covering, in this case a pleated blind 19, is provided on its underside with a beam 20 which is carried by two cords 21, 22 which can be wound onto respective reels 23, 24 which are both mounted on a common rotation shaft supported in bar 4 by bearings (not shown). Said shaft 25 also carries a drive roller 26 over which is trained an endless control cord 27. By exerting a downward directed force 28 on the rear part of cord 27 an upward directed force 29, 30 is exerted on cords 21 and 22, whereby beam 20 is displaced upward as according to arrow 31.

Cords 21, 22 are placed alternately through perforations in pleated blind 19, whereby in addition to raising and lowering, they also ensure correct positioning of blind 19.

Cords 21 and 22 extend through holes 11 and 12. Control cord 27 extends through hole 13. As described above, these holes are all present in profiled bar 4 according to the invention.

FIG. 4 shows a bar 32 in a particular embodiment according to the invention. This has an internal prismatic first cavity 33 for accommodating the horizontal part of cords 7, 8 (see FIG. 2). On the underside the bar 32 has continuous holes 11, 12, 13.

Bar 32 further has on both sides a prismatic second cavity 34 and 35 respectively which extends in the longitudinal direction of bar 32 and which debouches onto the outside of bar 32 via a constriction 36, 37 respectively. As shown clearly in FIG. 4, the rear second cavity drawn on the left in FIG. 4 serves in this case to receive the upper edge 38 of roller blind 5, which upper edge is embodied such that it fits into said second cavity 34 but is too wide to pass through the constriction 36. A loop-shaped portion 39 is formed for this purpose on the end of roller blind 5 by means of a stitched seam 40, in which loop-shaped portion a rod or cord 41 is placed such that the above stated functionality is realized. It will be apparent that roller blind 5 can be removed and re-placed easily, for instance for cleaning, without the bar having to be disassembled into components in order to open the second cavity 34.

Attention is drawn in this respect to the fact that the bar 32 comprises two identical prismatic profiles 42, 43 in the zones 44, 45. Between the first cavity 33 and the second cavities 34 and 35 these profiles 42, 43 are glued to each other. In respect of assembly it is therefore practical to place the cords 7, 8 beforehand through holes 11, 12, 13.

As FIG. 4, and also FIG. 5 show, holes 11, 12, 13 are rounded off at their ends. This prevents wear of the cords and ensures that the cords can follow the 90° transitions with little friction.

FIG. 5 shows the cross-section V-V of FIG. 1.

As FIG. 1 shows, bar 4 is fixed by means of two screws 45, 46 to the upper beam of frame 2. Screws 45, 46 extend through holes 47, 48 respectively in the lower profile 42 and upper profile 43. The heads 49, 50 support the bar 4.

In order to replace or temporarily remove roller blind 5, screws 45, 46 can be loosened, whereafter the upper edge 38 of the roller blind 5 is slid in longitudinal direction out of the left-hand second cavity. The open ends of the second cavities 34, 35 are not closed for this reason. The open ends of the first cavity 33 are however preferably closed, this with a wooden plug. The end of bar 32 hereby provides the view as according to FIG. 4, wherein the seams 44, 45 and the periphery of the plug and cavity 33 respectively can still be discerned slightly.

FIGS. 6A, 6B, 7 and 8 show two alternatives in which the beam according to the invention can be or is fixed to the building construction, in this case the upper beam 3 of a frame 2, by means of an extruded aluminium mounting profile 71.

In the embodiment of FIG. 6A the two profiles, embodied as identical prismatic profiles, are manufactured from wood and designated with reference numerals 42′, 43′ respectively. In the embodiment of FIGS. 6B, 7 and 8 the two profiles, embodied as identical prismatic profiles, are manufactured from a plastic, for instance a transparent plastic, or aluminium. The profiles can for instance be manufactured by extrusion. In order to distinguish these latter from profiles 42′, 43′ according to FIG. 6A, which are manufactured from wood, the profiles in FIGS. 6B, 7 and 8 are designated with reference numerals 42″, 43″.

The upper profile 43′ has on its top surface a small recess in which the extruded aluminium mounting profile 71 is received in slightly recessed manner. As shown particularly clearly in FIG. 7, profile 71 has a general U-shape with two support edges 72, 73 on the ends of the legs of the U which are directed toward each other. These edges serve as support edges for a connecting strip 74 with two tongues 75, 76 which can be rotatably connected (FIG. 7) or is rotatably connected (FIGS. 6A, 6B, 8) to upper beam 3. These tongues 75, 76 can engage in the space under support edges 72, 73 in the manner shown particularly clearly in FIG. 8. Strip 74 has for this purpose a control lever 77 which extends substantially transversely of tongues 75, 76 and which can be rotated as according to an arrow 78 (FIG. 8) while simultaneously rotating the tongues 75, 76 out of the free position shown in FIG. 7 to the fixing position shown in FIG. 8.

Via a ring 79, which comes to rest fixedly against upper beam 3, the strip 74 is secured to upper beam 3 by means of a self-tapping wood screw 80. The strip 3 is hereby rotatable through about a quarter-turn under the control of lever 74.

By first placing the bar 42″, 43″ in the orienting position shown in FIG. 7 and pressing it upward, it can first be brought roughly into position and then placed in the desired position, optionally with a further small displacement. Lever 77 is then rotated through about a quarter-turn by a simple movement, whereby bar 42″, 43″ is attached fixedly to upper beam 3. It will be apparent that a bar must always be fixed to a building construction by means of at least two of said fixing devices 74, 75, 76, 77, 79, 80. In the case of longer bars, even more than two of such devices placed in line may be applied.

Since the other components and elements in FIGS. 6A, 6B, 7 and 8 are the same as those according to FIG. 1 to 5, they are not further shown in the figures, and description thereof is dispensed with here.

1. A profiled bar intended for securement to the top side of a window, door or the like, which bar comprises:
an internal, preferably prismatic first cavity which extends in the longitudinal direction of the bar for accommodating a raising mechanism for raising cords for a variable covering for the window, door or the like, such as a roller blind, a pleated blind or the like, which internal cavity is accessible from the exterior via at least one continuous hole in the bar for passage of at least one control cord which may be connected to the underside of the covering, for instance a substantially rigid beam connected to the lower edge of the covering;
at least one prismatic second cavity which extends in the longitudinal direction of the bar and which opens via a constriction onto the outside of the bar, which second cavity serves to receive the upper edge of the covering, which is embodied such that it fits into this second cavity but is too thick to pass through the constriction; and
two mutually coupled profiles which together bound the first cavity, in at least one of which profiles said holes are present.

2. A profiled bar as claimed in claim 1, wherein the two profiles consist of wood or a wood-like material.

3. A profiled bar as claimed in claim 1 wherein the two profiles are prismatic.

4. A profiled bar as claimed in claim 1, wherein both ends of the bar have opening which connect onto the first cavity and which are each closed by a plug.

5. A profiled bar as claimed in claim 4, wherein the plugs consist of the same material as the two profiles.

6. A profiled bar as claim in, wherein the bar has continuous holes through which fastening screws can be placed to fasten the bar to the top part of a window, door or the like.

7. A profiled bar as claimed in claim 1, wherein the two profiles are mirror-symmetrical.

8. A profiled bar as claimed in claim 7, wherein the two profiles are identical.

9. A profiled bar as claimed in claim 7, wherein the two profiles are mutually coupled in the plane of symmetry extending through the prismatic second cavity.

10. A profiled bar as claimed in claim 1, wherein the edge of the at least one hole is rounded.

11. A profiled bar as claimed in claim 1, wherein the profiles are connected non-releasably to each other, for instance by glueing.

12. A profiled bar as claimed in claim 1, wherein the raising mechanism comprises:
a drive roller onto which the control cord engages for rotating driving thereof; and
a number of wind-up rollers for raising cords which are connected to this drive roller, for instance are arranged on the same shaft therewith.

13. A profiled bar as claimed in claim 1, wherein the raising mechanism comprises:
guide means for the raising cords which are also the control cords;
wherein each of the cords is connected with a fixed end to the bar, extends downward and is trained through 180° around the upward windable or at least partially lower zone of the covering, extends upward again, enters the first cavity via a raising cord hole, extends therein in substantially horizontal direction leaves the cavity once again via a control cord hole and extends downward therefrom in vertical direction.

14. A profiled bar as claimed in claim 1, wherein the two profiles consist of a transparent material, for instance a plastic such as acrylic, polycarbonate or plexiglass.

15. A profiled bar as claimed in claim 1, wherein the two profiles consist of a metal, for instance aluminum.

16. A profiled bar as claimed in claim 1, wherein the two profiles consist of an opaque plastic, for instance PVC, PP or PE.

17. A profiled bar as claimed in claim 3, wherein the two profiles are each manufactured by extrusion.

18. A profiled bar as claimed in claim 1, wherein at least one of the two profiles is provided with a mounting profile, via which the relevant part can be fixed to the building structure.

19. A profiled bar as claimed in claim 18, wherein the mounting profile takes a prismatic form.

20. A profiled bar as claimed in claim 19, wherein the mounting profile is manufactured by extrusion.

21. A profiled bar for securement to the top of an opening, including:
a first internal longitudinal cavity to accommodate a raising mechanism for adjusting an attached covering for the opening;
at least one opening into the cavity to accommodate at least one control cord which may be connected to the lower edge of the covering; and
at least one second longitudinal cavity having a constricted opening along one edge of the bar of a size to accept one edge of the covering and which will prevent passage through the constriction.
